(19) United States
(12) Patent Application Publication
(10) Pub. No.: US 2020/0261912 A1
(43) Pub. Date: Aug. 20, 2020

(54) METHOD FOR GENERATING MICRO SAMPLES AND GENERATION CHIP

(71) Applicant: BOE Technology Group Co., Ltd., Beijing (CN)

(72) Inventor: Yudan YIN, Beijing (CN)

(21) Appl. No.: 16/645,535

(22) PCT Filed: Aug. 7, 2019
(86) PCT No.: PCT/CN2019/099630

§ 371 Date: Mar. 9, 2020

(30) Foreign Application Priority Data
Oct. 15, 2018 (CN) 20181198944.9

(51) Int. Cl. B01L 3/00; B01L 3/02

(52) U.S. Cl. CPC B01L 3/502761; B01L 3/0268; B01L 2200/0636; B01L 2400/0439; B01L 2200/0673; B01L 2300/0864; B01L 2400/02; B01L 2200/0652

(57) ABSTRACT

A method for generating micro samples and a generation chip. The method includes: simultaneously adding polyelectrolyte solutions with opposite charges respectively at a set flow rate to at least one pair of liquid inlet holes of pretreated generation chip of micro samples; wherein proportions of positive charges and negative charges of the polyelectrolyte solutions added to the pair of liquid inlet holes are substantively same; respectively controlling sample inlet channels through which the polyelectrolyte solutions in the liquid inlet holes enter the generation chip to be communicated with the liquid inlet holes; and controlling convergence of the polyelectrolyte solutions entering the sample inlet channels in a main channel of the generation chip, and forming in situ micro samples of a compound with a set diameter in the main channel within a set recombination time.

### CROSS-REFERENCE TO RELATED APPLICATIONS

The present disclosure is a National Stage of International Application No. PCT/CN2019/099630, filed on Aug. 7, 2019, which claims the priority of Chinese patent application No. 201811198944.9, filed with Chinese Patent Office on Oct. 15, 2018, and entitled “Method for generating micro samples and Generation Chips”, the contents of which are incorporated by reference herein in its entirety.

### FIELD

The present disclosure relates to the technical field of biomedicine, in particular to a method for generating micro samples and generation chip.

### BACKGROUND

The micro-droplet technology is a micro-nano technology in which the interaction between flow shear force and surface tension is utilized to segment continuous fluid into discrete droplets of a nanoscale volume and below in a microscale channel. The micro-droplet technology is a brand new technology to manipulate volume of tiny liquid which has been developed in recent years.

### SUMMARY

Some embodiments of the present disclosure provide a method for generating micro samples, including:

simultaneously adding polyelectrolyte solutions with opposite charges respectively at a set flow rate to at least one pair of liquid inlet holes of pretreated generation chip of micro samples; wherein proportions of positive charges and negative charges of the polyelectrolyte solutions added to each pair of liquid inlet holes are substantively same;

respectively controlling sample inlet channels through which the polyelectrolyte solutions in the liquid inlet holes enter the generation chips to be communicated with the liquid inlet holes; and

controlling convergence of the polyelectrolyte solutions entering the sample inlet channels in a main channel of the generation chip, and forming in situ micro samples of a compound with a set diameter in the main channel within a set recombination time.

Optionally, in some embodiments of the present disclosure, the longer the set recombination time is, the higher the concentration of the polyelectrolyte solutions is, and the bigger the diameter of the micro samples of a compound is.

Optionally, in some embodiments of the present disclosure, in response to that the set recombination time is unchanged the higher the concentration of the polyelectrolyte solutions is, the bigger the diameter of the micro samples of a compound is.

Optionally, in some embodiments of the present disclosure, the polyelectrolyte solution is a mixture of DNA solution and FITC-labeled polylysine solution;

a concentration ratio of the DNA solution to the FITC-labeled polylysine solution is 1.5:1.

Optionally, in some embodiments of the present disclosure, the concentration of the FITC-labeled polylysine solution is in a range of 1 mg/mL to 4 mg/mL; and the concentration of the DNA solution is in a range of 1.5 mg/mL to 6 mg/mL.

Optionally, in some embodiments of the present disclosure, the concentration of the FITC-labeled polylysine solution is 1 mg/mL, and the concentration of the DNA solution is 1.5 mg/mL;

the forming in situ micro samples of a compound with a set diameter in the main channel within a set recombination time includes:

forming in situ micro samples of a compound with a diameter of 20 μm in the main channel when the set recombination time is 4 minutes.

Optionally, in some embodiments of the present disclosure, the concentration of the FITC-labeled polylysine solution is 4 mg/mL, and the concentration of the DNA solution is 6 mg/mL;

the forming in situ micro samples of a compound with a set diameter in the main channel within a set recombination time includes:

forming in situ micro samples of a compound with a diameter of 20 μm in the main channel when the set recombination time is in a range of 1.5 minutes to 2 minutes.

Optionally, in some embodiments of the present disclosure, the step of respectively adding polyelectrolyte solutions with opposite charges at a set flow rate includes:

adding polyelectrolyte solutions with opposite charges respectively at set flow rates which are substantively same.

Optionally, in some embodiments of the present disclosure, the set flow rate is less than or equal to 1 μL/min.

Optionally, in some embodiments of the present disclosure, after forming micro samples of a compound with a set diameter, the generation method further includes: removing waste liquid from the liquid inlet holes and the liquid storage holes which are communicated with the main channel of the generation chip.

Optionally, in some embodiments of the present disclosure, after the waste liquid is removed, the method further includes: adding buffer solution to the liquid inlet holes and the liquid storage holes.

Optionally, in some embodiments of the present disclosure, the pretreatment of the generation chip includes:

treating the generation chip of the micro samples by adopting concentrated sulfuric acid, and flushing the generation chip of the micro samples treated with concentrated sulfuric acid by adopting secondary deionized water;

treating the generation chip of the micro samples flushed with the secondary deionized water by adopting a sodium hydroxide solution, and flushing the generation chip of the micro samples treated with the sodium hydroxide solution by adopting the secondary deionized water; and

treating the generation chip of the micro samples flushed with the secondary deionized water by adopting a hydrochloric acid solution, and flushing the generation chip of the micro samples treated with the hydrochloric acid solution by adopting secondary deionized water, such that the sample inlet channels and the main channel of the generation chip of the micro samples are substantively neutral.

Optionally, in some embodiments of the present disclosure, after pretreating the generation chip of the micro samples, and before adding polyelectrolyte solutions with opposite charges at a set flow rate to at least one pair of liquid inlet holes of pretreated generation chip of micro samples, the method further includes: flushing the generation chip of the micro samples by adopting a buffer solution.

Optionally, in some embodiments of the present disclosure, the buffer solution is a 0.2×PBS solution containing polyvinylpyrrolidone;

a mass percentage of polyvinylpyrrolidone is 1%.

Some embodiments of the present disclosure further provide generation chip of micro samples, including: a substrate, a main channel arranged on the substrate, at least one pair of liquid inlet holes, and sample inlet channels which are in one-to-one correspondence with the liquid inlet holes, wherein

one end of the sample inlet channel is communicated with a corresponding liquid inlet hole, and the other end is communicated with the main channel;

mirror images of two liquid inlet holes in the pair of liquid inlet holes are arranged at two sides of an extension direction of the main channel, the pair of liquid inlet holes are configured to be respectively added with polyelectrolyte solutions with opposite charges at a set flow rate, such that the polyelectrolyte solutions in the liquid inlet holes are converged at the main channel of the generation chip respectively through the sample inlet channels of the generation chip, and micro samples of a compound with a set diameter are generated in situ in the main channel in a preset recombination time; wherein proportions of positive charges and negative charges of the polyelectrolyte solutions added to the pair of liquid inlet holes are substantively same.

### BRIEF DESCRIPTION OF THE DRAWINGS

FIG. 1 is a flow chart of a generation method of some generation chips provided in some embodiments of the present disclosure;

FIG. 2 is a flow chart of a generation method of some other generation chips provided in some embodiments of the present disclosure;

FIG. 3 is a structural schematic diagram of generation chips of some micro samples provided in some embodiments of the present disclosure;

FIG. 4 is a structural schematic diagram of generation chips of some other micro samples provided in some embodiments of the present disclosure;

FIG. 5 is a structural schematic diagram of generation chips of still some other micro samples provided in some embodiments of the present disclosure;

FIG. 6 is a structural schematic diagram of generation chips of still some other micro samples provided in some embodiments of the present disclosure;

FIG. 7 is a structural schematic diagram of generation chips of still some other micro samples provided in some embodiments of the present disclosure;

FIG. 8 is a structural schematic diagram of generation chips of still some other micro samples provided in some embodiments of the present disclosure;

FIG. 9 is a schematic diagram of a main channel in generation chips provided in some embodiments of the present disclosure.

### DETAILED DESCRIPTION OF THE EMBODIMENTS

In order to make the objectives, technical solutions, and advantages of the embodiments of the present disclosure clearer, the technical solutions of the embodiments of the present disclosure will be described below clearly and completely in combination with accompanying drawings of the present disclosure. Apparently, the embodiments described below are only a part but not all of the embodiments of the present disclosure. Moreover, without conflict, the embodiments in the present disclosure and the characteristics in the embodiments can be combined with each other. Based upon the described embodiments of the present disclosure, all of the other embodiments obtained by those skilled in the art without any creative effort shall all fall into the protection scope of the present disclosure.

Unless otherwise defined, the technical or scientific terms used in the present disclosure shall have a general meaning understood by those skilled in the art to which the present disclosure belongs. The terms “first”, “second” and the like used in the present disclosure do not indicate any order, quantity, or importance, but are only used to distinguish different components. Words like “include” or “contain” mean that the element or object preceding the word covers the element or object listed after the word and its equivalent, without excluding other elements or objects. Words like “connection” or “connected” are not limited to physical or mechanical connections, but can include electrical connections, whether direct or indirect connections.

It should be noted that, the sizes and shapes of the figures in the accompanying drawings do not reflect the true proportions and are intended only to illustrate the contents of the present disclosure. Moreover, the same or similar reference numerals throughout the text represent the same or similar elements or elements with the same or similar functions.

Microfluidic chips were initially originated from a micro total analysis system (μTAS) proposed by Manz and Widmer in the 1990s. Professor Manz successfully applied the micro electro mechanical system (MEMS) technology to the field of analytical chemistry, and realized high-speed capillary electrophoresis on microchips soon afterwards. The results were published on such magazines as Science, and since then, this field has rapidly gained academic attention, and has become one of the forefront science and technology fields in the world nowadays. Lab on a chip and microfluidic chip are both different names proposed to this field, while along with the expansion of the applications of this discipline from the original analytic chemistry to multiple research and application fields, and along with thorough understanding of this discipline by researchers, microfluidic chip has become a general term of this field.

The micro-droplet technology is a micro-nano technology in which the interaction between flow shear force and surface tension is utilized to segment continuous fluid into discrete droplets of a nanoscale volume and below in a microscale channel. The micro-droplet technology is a brand new technology to manipulate volume of tiny liquid which has been developed in recent years. Till now, the micro-droplets reported in literatures are mainly divided into two types: gas-liquid droplets and liquid-liquid droplets. The applications of the gas-liquid droplets are limited since the gas-liquid droplets are easily volatile in the micro channels and cause cross contamination. The liquid-liquid droplets are divided into oil in water (O/W), water in oil (W/O), oil in water in oil (O/W/O), and water in oil in water (W/O/W) according to the differences in continuous phase and dispersed phase, can overcome shortcomings of volatilization of droplets and cross contamination, and are the focus of the development of microfluidic droplet technology. Owing to such advantages as small volume, no diffusion between droplet samples, prevention of cross contamination between samples, stable reaction conditions and rapid mixing under proper manipulation, the liquid-liquid micro-droplet is an ideal microreactor, and has been applied to chemistry and bioscience fields to research numerous reactions and processes thereof under microscale conditions, for example, chemical synthesis, microextraction, protein crystallization, enzymatic synthesis and activity analysis thereof, cell embedding, droplet PCR, etc.

Polyelectrolyte compounds were first recognized on the basis of interactions between proteins to produce precipitation. At the end of the 19th century, Kossel first discovered the electrostatic nature of the interaction between anions and cations of polyelectrolyte compounds. In the 1950s, Michael systematically researched a polyelectrolyte compound formed by polystyrolsulfon acid and poly (vinylbenzyl trimethyl ammonium chloride). Afterwards, as a novel material, researches on the formation, physical and chemical properties and applications of the polyelectrolyte compound (PEC) have made greater progress. Under certain conditions, polyionic compounds can be formed through interaction between two polyelectrolytes with opposite charges. The polyelectrolyte participating in the reaction includes polymer acids, polymer alkali and polymer salts, and even involves certain biomacromolecules and ionic surfactant. In addition to organic polyelectrolyte, inorganic compounds such as polyphosphates and polysilicate can also form polyelectrolyte compounds. In the recombination process of polyanions (PA)-polycations (PC), soluble and even water-soluble linear or branched-chain macromolecules are generally adopted. The acting forces in polyelectrolyte compounds include electrostatic interaction, hydrophobic interaction, hydrogen bonding and van der Waals forces. In the reaction, due to the long-chain structure of polyelectrolyte molecules, once a certain pair of chain segments between reactant molecules undergo a composite reaction, the adjacent chain segments are more likely to undergo the composite reaction because no significant change in molecular configuration is required. The polyelectrolyte compound and the original components are dramatically different in performance, so they have different application ranges. Many biological functions, such as transmission of genetic information, selectivity of enzyme, and antibody-antigen action, are mainly based on interaction between biomacromolecules or interaction between biomacromolecules or small molecule compounds. Since many similarities exist between the polyelectrolyte compound and the biomacromolecules in terms of structures and performances (such as surface charge, hydrophilicity and hydrophobicity, and selective transport of micromolecule substances), the polyelectrolyte compound has great application prospects in biomedical materials, such as film, biocompatible materials, medicine controlled release system, medicine and zymophores, etc.

As shown in FIG. 1, some embodiments of the present disclosure provide a method for generating micro samples, and the generation method can include the following steps:

S101, simultaneously adding polyelectrolyte solutions with opposite charges respectively at a set flow rate to at least one pair of liquid inlet holes of a pretreated generation chip of micro samples; wherein the proportions of positive charges and negative charges of the polyelectrolyte solutions added to each pair of liquid inlet holes are substantively the same;

S102, respectively controlling sample inlet channels through which the polyelectrolyte solutions in the liquid inlet holes enter the generation chip to be communicated with the liquid inlet holes; and

S103, controlling convergence of the polyelectrolyte solutions entering the sample inlet channels in a main channel of the generation chip, and forming in situ micro samples of a compound with a set diameter in the main channel within a set recombination time.

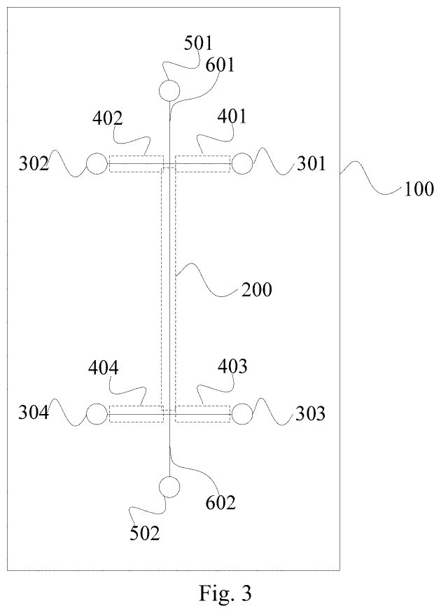

Optionally, for example, with the generation chip as shown in FIG. 3 as an example, the liquid inlet hole 301 and the liquid inlet hole 302 are a pair of liquid inlet holes, while the liquid inlet hole 303 and the liquid inlet hole 304 are another pair of liquid inlet holes. 10 μL of polyelectrolyte solutions with opposite charges are respectively added to the liquid inlet holes 301 and 302 (or 303 and 304). Under the effect of gravity, the two liquid flows will be converged at the main channel 200 through the sample inlet channels 401 and 402 (or 403 and 404), and form micro-droplets of the compound (that is, micro samples of the compound) in the middle of the main channel 200.

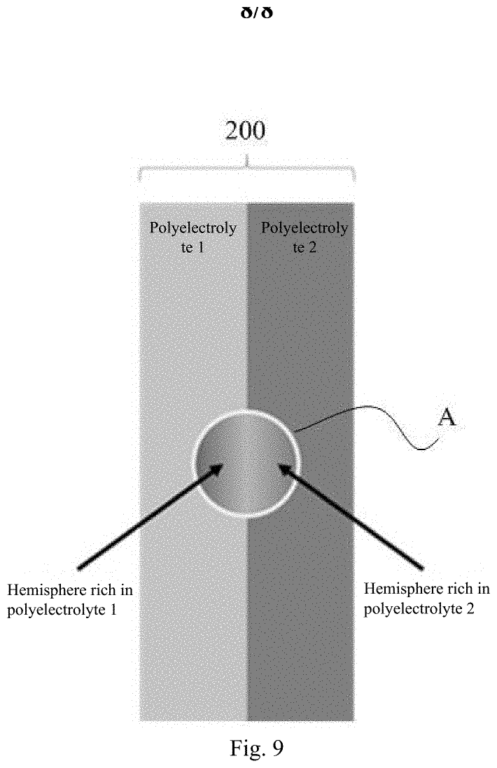

Optionally, in the above generation method provided in some embodiments of the present disclosure, a generation chip with liquid inlet holes and a main channel is adopted as a platform, samples are injected into a pair of liquid inlet holes simultaneously by utilizing two polyelectrolyte solutions which have opposite charges and substantively the same molecular proportions, such that the polyelectrolyte solutions are converged in the main channel, and micro-droplets with normalized shapes and orderly arrangement can be formed in situ in different sites by utilizing the liquid phase separation effect of the compound. Wherein in situ generation means that the micro-droplets are formed in the same position from nucleation to formation of micro-droplets with a proper particle size, while different sites mean that the liquid converged interface of two polyelectrolyte solutions in the main channel 200 as shown in FIG. 9 are the sites for generating micro-droplets. Compared with the generation mode of traditional droplet generators, that is, a mode in which the micro-droplets generated at the same position need to be brought away by liquid flow to continuously generate micro-droplets, the problem of solution waste caused by viscous adhesion of generated micro-droplets which require a large amount of liquid flow to flush so as to continuously generate droplets can be avoided.

Moreover, as shown in FIG. 9, in the process of forming micro-droplets, since the micro-droplet A generated at the liquid converged interface of two polyelectrolyte solutions of the main channel 200 is in two different adjacent environments, the micro-droplet A itself correspondingly possesses the property of anisotropy, that is, janus particle.

Optionally, in the above generation method provided in some embodiments of the present disclosure, biomacromolecules can be directly used as generation materials of droplets, that is, the raw materials to be added to the liquid inlet holes, thereby avoiding exogenous stimulation of other synthesized substances to organisms. Moreover, the micro-droplets generated by adopting the above generation method are closer to the actual organism environment: the generated micro-droplets of polyelectrolyte compound have a higher pH stability and temperature stability. The generated micro-droplets provide a relatively molecular crowding state, which is closer to the actual organism (cell) microenvironment. The generated micro-droplets provide a state in which biomolecules are enriched in great quantities. The generated micro-droplets provide an enhanced catalytic conversion activity, and provide a dielectric constant lower than the surrounding water environment.

Moreover, in the above generation method provided in some embodiments of the present disclosure, the generated micro-droplets can be precisely regulated through controlling such parameters as concentration, components and recombination time of polyelectrolyte solutions which generate the micro-droplets. It should be noted that, due to special properties of the macromolecules themselves, the parameters of the used polyelectrolyte solutions will be changed greatly along with a change in the type of polyelectrolyte. Moreover, the components of micro-droplets are closely related to the components of polyelectrolyte solutions, however, the components of micro-droplets will also be influenced by properties of the polyelectrolyte itself, for example, recombination efficiency, etc.

Optionally, in the above generation method provided in some embodiments of the present disclosure, the polyelectrolyte solutions with opposite charges can be a mixture of DNA solution and FITC-labeled polylysine (PLL) solution. Wherein the DNA solution can be oligonucleotide (ss-Oligo) solution. Moreover, since the positive charges and negative charges in the polyelectrolyte solutions need to be just neutral, the charge density of the used polyelectrolyte solutions needs to be considered. Exemplarily, the ratio of the concentration of the DNA solution to the concentration of the FITC-labeled polylysine solution is 1.5:1, that is, the concentration ratio of the DNA solution to the FITC-labeled polylysine solution is 1.5:1. Of course, the present disclosure includes but is not limited to this.

Optionally, in the above generation method provided in some embodiments of the present disclosure, the concentration of the FITC-labeled polylysine solution is in a range of 1 mg/mL to 4 mg/mL; and the concentration of the DNA solution is in a range of 1.5 mg/mL to 6 mg/mL. Exemplarily, the concentration ratios of the FITC-labeled polylysine solution to the DNA solution suitable for forming micro-droplets are 1.0 mg/mL:1.5 mg/mL to 4.0 mg/mL:6.0 mg/mL. Of course, the present disclosure includes but is not limited to this.

Optionally, in the above generation method provided in some embodiments of the present disclosure, the step of respectively adding polyelectrolyte solutions with opposite charges at a set flow rate can include: adding polyelectrolyte solutions with opposite charges respectively at set flow rates which are substantively the same. The flow rates in each pair of liquid inlet holes are generally set to be the same, such that the liquid converged interface of the two polyelectrolyte solutions is relatively stable in the main channel. Moreover, the smaller the set flow rate is, the better the effect of generated micro-droplets is, however, the poorer the generation effect is. Therefore, in overall consideration, the flow rate is generally set to be smaller than or equal to 1 μL/min. Exemplarily, the set flow rate can be set to 1 μL/min, the set flow rate can also be set to 0.8 μL/min, the set flow rate can also be set to 0.5 μL/min, and the set flow rate can also be set to 0.3 μL/min. Of course, the present disclosure includes but is not limited to the set flow rates herein.

Optionally, in the above generation method provided in some embodiments of the present disclosure, the set diameters of the micro samples of a compound can be 20 μm, 15 μm, 25 μm, 30 μm, 10 μm, etc. Of course, in actual applications, since the designed diameters of micro samples of a compound required in different application environments may be different, the set diameter of the micro samples of the compound can be designed and determined according to actual requirements, and will not be limited herein.

Optionally, in the above generation method provided in some embodiments of the present disclosure, the recombination time is determined according to the size (diameter) of the required micro-droplets (that is, the micro samples of the compound) and the concentration of the polyelectrolyte. Generally speaking, the longer the set recombination time is, the higher the concentration of the polyelectrolyte solution is, the bigger the diameter of the micro samples of the compound is. Or, the higher the concentration of the polyelectrolyte solution is, if the recombination time is set unchanged, then the bigger the diameter of the micro samples of the compound is. Of course, the present disclosure includes but is not limited to this.

Optionally, in the above generation method provided in some embodiments of the present disclosure, when the concentration of FITC-labeled polylysine solution is 1 mg/mL, and the concentration of DNA solution is 1.5 mg/mL, during specific implementations, the step of forming in situ micro samples of a compound with a set diameter in the main channel within a set recombination time can include: forming in situ micro samples of a compound with a set diameter of 20 μm in the main channel when the set recombination time is 4 minutes. In this way, when the set recombination time is 4 minutes, the diameter of the generated micro samples of the compound can be substantively 20 μm.

Optionally, in the above generation method provided in some embodiments of the present disclosure, when the concentration of the FITC-labeled polylysine solution is 4 mg/mL, and the concentration of the DNA solution is 6 mg/mL, during specific implementation, the step of forming in situ micro samples of a compound with a set diameter in the main channel within a set recombination time can include: forming in situ micro samples of a compound with a set diameter of 20 μm in the main channel when the set recombination time is 1.5 minutes to 2 minutes. In this way, when the set recombination time is 1.5 minutes to 2 minutes, the diameter of the generated micro samples of the compound is substantively 20 μm.

Optionally, in the above generation method provided in some embodiments of the present disclosure, 200 μL of DAN (1.5 mg/mL) and FITC-labeled PLL (1.0 mg/mL) solutions can be respectively added to two 1.5 mL centrifugal tubes, the solutions are mixed (Vortex) for 10 seconds and then stand for 30 minutes, and then a pipette is used to extract 10 μL of droplet suspension to liquid inlet hoes 301 and 302 (or 303 and 304) corresponding to the generation chip.

Optionally, in the above generation method provided in some embodiments of the present disclosure, as shown in FIG. 1, after forming micro samples of a compound with a set diameter, the generation method can further include: S104, removing waste liquid from the liquid inlet holes and the liquid storage holes which are communicated with the main channel of the generation chip. In this way, the influence of the waste liquid on the diameter of the generated micro samples of the compound can be avoided. Exemplarily, for example, with the generation chip as shown in FIG. 3 as an example, when the micro-droplets of the compound (that is, micro samples of the compound) grow to have a diameter of about 10-20 μm, waste liquid in the liquid inlet holes 301 and 302 and waste liquid in the other four holes (liquid inlet holes 303 and 304 and liquid storage holes 501 and 502) are removed with a syringe.

Optionally, in the above generation method provided in some embodiments of the present disclosure, as shown in FIG. 1, after waste liquid is removed, the generation method can further include: S105, adding buffer solution to the liquid inlet holes and the liquid storage holes. In this way, micro samples of the compound can be diluted for subsequent electrical detection. Exemplarily, the buffer solution can be: 0.2×PBS solution containing polyvinylpyrrolidone, and the mass percentage of polyvinylpyrrolidone is 1%, that is, the buffer solution can be 0.2×PBS buffer solution containing 1% (w/w) polyvinylpyrrolidone solution. Exemplarily, for example, with the generation chip as shown in FIG. 3 as an example, after waste liquid is removed, each of the six holes (liquid inlet holes 301, 302, 303 and 304 and liquid storage holes 501 and 502) is added with 10 μL of 0.2×PBS buffer solution containing 1% (w/w) polyvinylpyrrolidone.

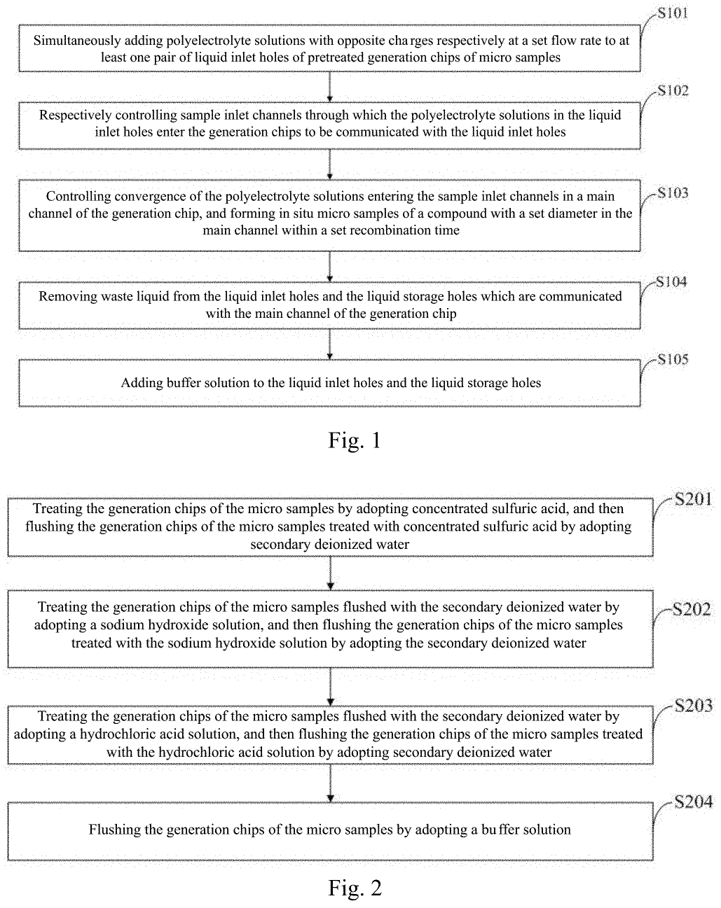

Optionally, in the above generation method provided in some embodiments of the present disclosure, as shown in FIG. 2, the step of pretreating the generation chip of the micro samples can specifically include:

S201, treating the generation chip of the micro samples by adopting concentrated sulfuric acid, and then flushing the generation chip of the micro samples treated with concentrated sulfuric acid by adopting secondary deionized water. For example, the generation chip of the micro samples are treated for 10 minutes with 98% concentrated sulfuric acid, and then flushed for 10 minutes with secondary deionized water, so as to play a role of hydroxyl activation, and enable the surface of a glass substrate to be more hydrophilic;

S202, treating the generation chip of the micro samples flushed with the secondary deionized water by adopting a sodium hydroxide solution, and then flushing the generation chip of the micro samples treated with the sodium hydroxide solution by adopting the secondary deionized water. For example, the generation chip of micro samples treated in step 201 are treated for 2 h with 1 mol/L of sodium hydroxide solution, and then flushed for 10 minutes with secondary deionized water, to play a role of neutralizing treatment, and remove grease from the main channel and the sample inlet channels;

S203, treating the generation chip of the micro samples flushed with the secondary deionized water by adopting a hydrochloric acid solution, and then flushing the generation chip of the micro samples treated with the hydrochloric acid solution by adopting secondary deionized water, such that the sample inlet channels and the main channel of the generation chip of the micro samples are substantively neutral. For example, the generation chip of micro samples treated in step 202 are treated with 1 mol/L of hydrochloric acid solution for 10 minutes, such that the main channel and the sample inlet channels are kept neutral, and then flushed with secondary deionized water for 10 minutes, to neutralize the hydroxy.

Moreover, when the generation chip is not used, it is generally stored in secondary deionized water to prevent dryness, otherwise, the above pretreatment should be performed again.

Optionally, in the above generation method provided in some embodiments of the present disclosure, as shown in FIG. 2, after pretreating the generation chip of the micro samples, and before adding polyelectrolyte solutions with opposite charges at a set flow rate to at least one pair of liquid inlet holes of pretreated generation chip of micro samples, the generation method further includes: S204, flushing the generation chip of the micro samples by adopting a buffer solution. In this way, the surface of the generation chip can be dynamically coated, to inhibit electroosmotic flow in the electrophoresis and surface adsorption of polylysine (PLL), so as to facilitate follow-up detection and use of micro samples. For example, before the generation chip are used each time, 1% (w/w) polyvinylpyrrolidone solution is prepared with 0.2×PBS buffer solution, and the generation chip are flushed for 10 minutes.

The method for generating micro samples provided in some embodiments of the present disclosure will be described below through embodiments. It should be noted that, the specific process of the generation method is not limited herein.

The method for generating micro samples provided in some embodiments of the present disclosure can include:

(1) treating the generation chip of micro samples with 98% concentrated sulfuric acid for 10 minutes, and then flushing with secondary deionized water for 10 minutes, so as to play a role of hydroxyl activation, and enable the surface of a glass substrate to be more hydrophilic;

(2) treating the generation chip of the micro samples treated in step S201 by adopting 1 mol/L of sodium hydroxide solution for 2 h, and then flushing with secondary deionized water for 10 minutes, to play a role of neutralizing treatment, and remove grease from the main channel and the sample inlet channels;

(3) treating the generation chip of micro samples treated in step 202 with about 1 mol/L of hydrochloric acid solution for 10 minutes, such that the main channel and the sample inlet channels are kept neutral, and then flushing with secondary deionized water for 10 minutes, to neutralize the hydroxy;

(4) preparing 1% (w/w) polyvinylpyrrolidone solution with 0.2×PBS buffer solution, and flushing the generation chips for 10 minutes;

(5) respectively adding 200 μL of DAN (1.5 mg/mL) solution and FITC-labeled PLL (1.0 mg/mL) solution to two 1.5 mL centrifugal tubes, standing for 30 minutes after mixing (Vortex) for 10 seconds, using a pipette to extract 10 μL of droplet suspension (that is, polyelectrolyte solution) to liquid inlet hoes 301 and 302 (or 303 and 304) corresponding to the generation chips, and simultaneously adding polyelectrolyte solutions with opposite charges to the liquid inlet hoes 301 and 302 at a set flow rate of 1 μL/min;

(6) respectively controlling sample inlet channels through which the polyelectrolyte solutions in the liquid inlet holes 301 and 302 enter the generation chips to be communicated with the liquid inlet holes;

(7) forming in situ micro samples of compounds with a set diameter of 20 μm in the main channel when the set recombination time is 4 minutes. The diameter of the generated micro samples of the compound is substantively 20 μm when the set recombination time is 4 minutes.

Based on the same inventive concept, some embodiments of the present disclosure further provide a generation chip of micro samples, as shown in FIG. 3, the generation chip includes: a substrate 100, a main channel 200 arranged on the substrate 100, at least one pair of liquid inlet holes 301 and 302 (303 and 304), and sample inlet channels 401 and 402 (403 and 404) which are in one-to-one correspondence with the liquid inlet holes 301 and 302 (303 and 304), wherein

one end of the sample inlet channels 401 and 402 (403 and 404) is communicated with the corresponding liquid inlet holes 301 and 302 (303 and 304), and the other end is communicated with the main channel 200;

mirror images of two liquid inlet holes 301 and 302 (or 303 and 304) in each pair of liquid inlet holes 301 and 302 (303 and 304) are arranged at two sides of an extension direction of the main channel 200, and it can be deemed that the distances from one pair of liquid inlet holes 301 and 302 (or 303 and 304) to the main channel 200 are the same, the connecting line of a pair of liquid inlet holes 301 and 302 (or 303 and 304) is vertical to the extension direction of the main channel 200, and a pair of liquid inlet holes 301 and 302 (or 303 and 304) constitute a convective structure relative to the main channel 200. Each pair of liquid inlet holes are configured to be respectively added with polyelectrolyte solutions with opposite charges at a set flow rate, such that the polyelectrolyte solutions in the liquid inlet holes are converged at the main channel of the generation chips respectively through the sample inlet channels of the generation chips, and micro samples of a compound with a set diameter are formed in situ in the main channel in a preset recombination time; wherein the proportions of positive charges and negative charges of the polyelectrolyte solutions added to each pair of liquid inlet holes are substantively the same.

Optionally, in the above generation chip provided in some embodiments of the present disclosure, the convective structure constituted by the sample inlet channels 401 and 402 (403 and 404) and the main channel 200 is relatively simple. During use, the generation chip is used as a platform, polyelectrolyte solutions with opposite charges are respectively added to at least one pair of liquid inlet holes 301 and 302 (303 and 304) of pretreated generation chips, such that the polyelectrolyte solutions in the liquid inlet holes 301 and 302 (303 and 304) are converged in the main channel 200 respectively through the sample inlet channels 401 and 402 (403 and 404), and form micro samples of the compound, that is, generate polyelectrolyte condensate droplets, in the main channel 200. The droplet generation manner takes polycations and polyanions as reaction raw materials, and takes the generation chips of liquid inlet holes 401 and 402 (403 and 404) with mirror image distribution as a platform, then micro-droplets closer to the actual organism environment can be generated in a simpler manner, such that the droplets have such characteristics as highly homogeneous form and orderly arrangement. Compared with the existing droplet technology, the droplets have the advantages of stable pH and temperature, a relatively molecular crowding state, relative enrichment of biomolecules, enhanced catalytic conversion activity and lower dielectric constant compared with the surrounding water environment. Moreover, with a generation chip as a platform, the droplets can have the advantages of high throughput and convenient detection.

Optionally, the above generation chip provided in some embodiments of the present disclosure can be applied to micro-droplet systems required by in vitro diagnosis, medicinal screening, cell culture, immunofluorescence detection, and artificial cell, and specially can be applied to generation of polyelectrolyte condensate droplets.

Through microfluidics, basic operating units of sample preparation, reaction, separation and detection of biological, chemical and medical analysis processes can be integrated to a piece of chip of micrometer scale, to automatically finish the whole process of analysis. Owing to such advantages of lowered cost, short detection time and high sensitivity, the microfluidics shows a great prospect in such fields as biology, lineation and medicine. A microfluidic chip is also called as a lab-on-a-chip, has the advantages of miniaturization and integration, and can miniaturize basic functions of biological and chemical laboratories to a chip of only several square centimeters. The generation chips of the micro samples provided in some embodiments of the present disclosure can be microfluidic chips. Moreover, micro samples can be continuous fluid with the size being at a nanoscale or a micron scale, or can be discrete droplets, and this is not limited herein.

Optionally, in the above generation chip provided in some embodiments of the present disclosure, as shown in FIG. 3 to FIG. 8, in at least one end of the main channel 200, the main channel 200 is communicated with a pair of liquid inlet holes 301 and 302 (303 and 304) through sample inlet channels 401 and 402 (403 and 404).

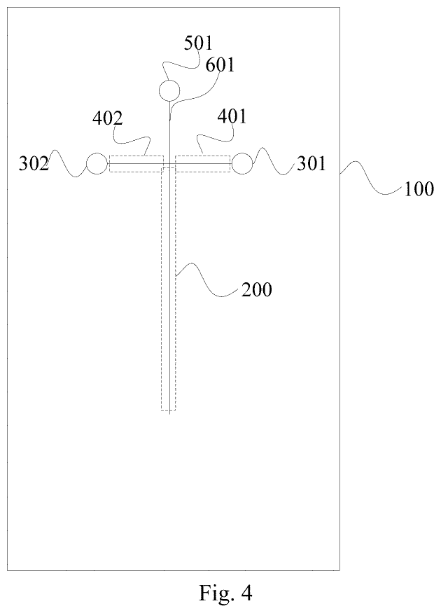

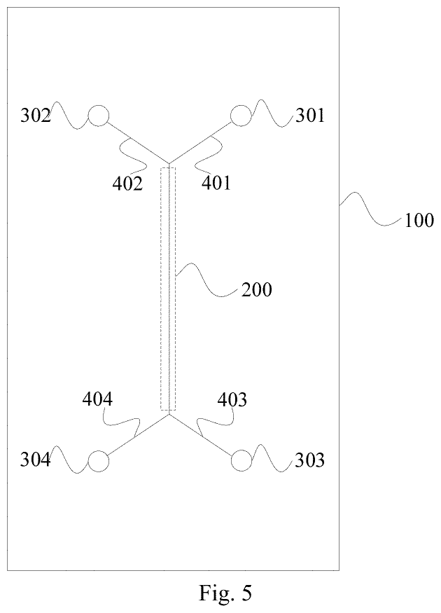

Optionally, as shown in FIG. 4, a pair of liquid inlet holes 301 and 302 can be arranged at only one end of the main channel 200. Or, as shown in FIG. 3, FIG. 5 to FIG. 8, a pair of liquid inlet holes 301 and 302 (303 and 304) can be respectively arranged at two ends of the main channel 200. Or, at least one pair of liquid inlet holes can be arranged at other positions of the main channel 200, and this is not limited herein.

Optionally, when multiple pairs of liquid inlet holes are arranged, reaction solutions can be respectively added to one or multiple pairs of liquid inlet holes to generate micro-droplets in the main channel 200, while other pairs of liquid inlet holes are used as liquid storage holes to discharge waste liquid, or used as detection holes for electrical detection, and the applications are not limited herein. For example, in the structure as shown in FIG. 3, reaction solutions can be respectively added to the liquid inlet holes 301 and 302 to generate micro-droplets in the main channel 200, while the liquid inlet holes 303 and 304 are used as liquid storage holes to discharge waste liquid, or used as detection holes for electrical detection, and the applications are not limited herein.

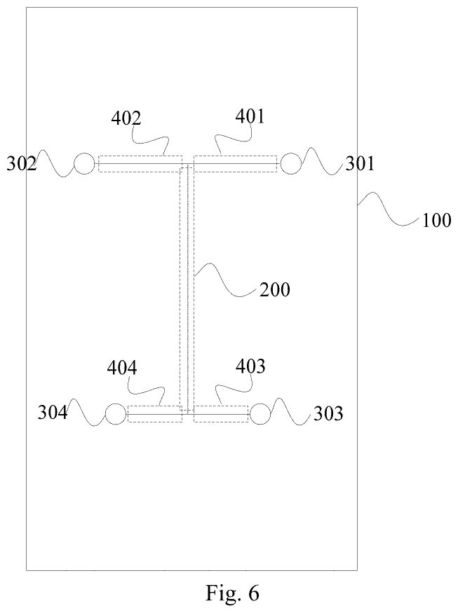

Optionally, in the above generation chip provided in some embodiments of the present disclosure, as shown in FIG. 3 to FIG. 8, the main channel 200 can be a linear-shaped channel, that is, the main channel 200 extends along a straight line, so as to facilitate flow of the micro samples generated in the main channel. As shown in FIG. 3, FIG. 4, FIG. 6 to FIG. 8, the sample inlet channels 401 and 402 (403 and 404) can be vertical to the extension direction of the main channel 200, to facilitate liquid (or droplets) adding to the liquid inlet holes 301 and 302 (303 and 304) to enter the main channel 200 through the sample inlet channels 401 and 402 (403 and 404) for convergence.

Or, as shown in FIG. 5, a certain angle (the angle is not a right angle) should also be formed between the sample inlet channels 401 and 402 (403 and 404) and the extension direction of the main channel 200, and this is not limited herein. It should be noted that, the included angles formed between the sample inlet channels 401 and 402 (or 403 and 404) connected through a pair of liquid inlet holes 301 and 302 (or 303 and 304) and the main channel 200 should be the same. The included angles formed between the sample inlet channels 401 and 402 (or 403 and 404) connected through different pairs of liquid inlet holes 301 and 302 (or 303 and 304) and the main channel 200 are not limited.

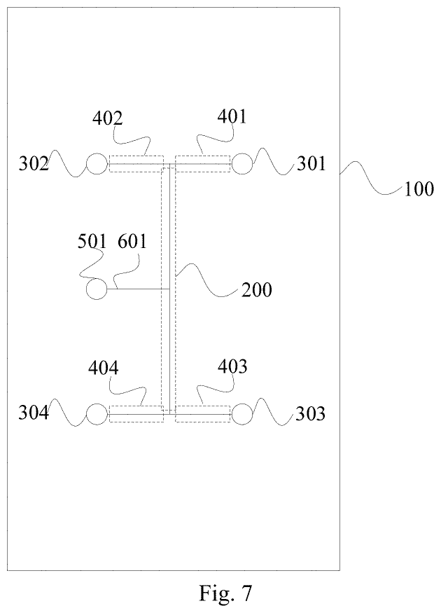

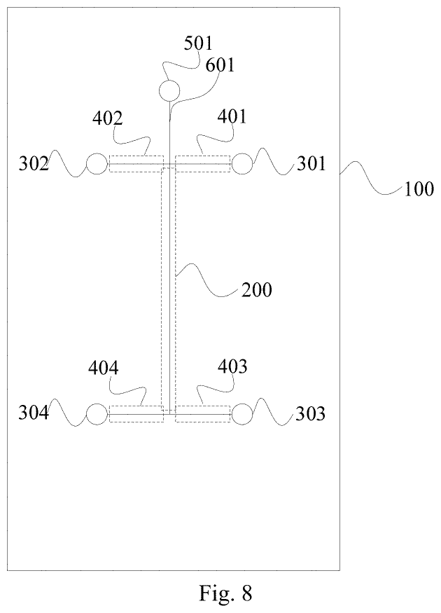

Optionally, in the above generation chip provided in some embodiments of the present disclosure, as shown in FIG. 3, FIG. 5, FIG. 7 and FIG. 8, at two ends of the main channel 200, the main channel 200 can be respectively communicated with the two pairs of liquid inlet holes 301 and 302 (303 and 304) through sample inlet channels 401 and 402 (403 and 404). The lengths of the sample inlet channels 401, 402, 403 and 404 are the same, such that multiple pairs of liquid inlet holes 301 and 302 (303 and 304) can be used alternately.

Or, as shown in FIG. 6, the lengths of the sample inlet channels 401 and 402 are the same, the lengths of the sample inlet channels 403 and 404 are the same, but the lengths of the sample inlet channels 401 and 403 are different, such that liquid inlet holes corresponding to different lengths of sample inlet channels should be selected according to the property of micro samples which need to be generated.

Optionally, in the above generation chip provided in some embodiments of the present disclosure, as shown in FIG. 3, FIG. 4, FIG. 7 and FIG. 8, the generation chip can further include: liquid storage holes 501 and 502 arranged on the substrate 100, and connecting channels 601 (corresponding to the liquid storage hole 501) and 602 (corresponding to the liquid storage hole 502) which are in one-to-one correspondence with the liquid storage holes 501 and 502;

one end of the connecting channels 601 and 602 is communicated with the corresponding liquid storage holes 501 and 502, while the other end is communicated with the main channel 200.

Optionally, the liquid storage holes 501 and 502 are used for discharging waste liquid after micro samples are generated, can also be used for adding buffer solution to dilute micro samples during electrical detection, and can also be used as detection holes during electrical detection, and the applications are not limited herein.

Optionally, in the above generation chips provided in some embodiments of the present disclosure, as shown in FIG. 3, FIG. 4 and FIG. 8, in at least one end of the main channel 200, the main channel 200 is communicated with the liquid storage holes 501 and 502 through connecting channels 601 and 602.

Optionally, as shown in FIG. 3, liquid storage holes 501 and 502 can be respectively arranged at two end parts of the main channel 200, as shown in FIG. 4 and FIG. 8, a liquid storage hole 501 can be only arranged at one end part of the main channel 200. The arrangement of liquid storage holes 501 and 502 at the end part of the main channel 200 is beneficial for the flowing of liquid from the main channel 200 to the liquid storage holes 501 and 502. Or, as shown in FIG. 7, the liquid storage hole 501 can also be arranged at the non-end-point part of the main channel 200, for example, the liquid storage hole 501 is arranged at the middle position of the main channel 200, and this is not limited herein. When a liquid storage hole 501 is arranged in the middle position of the main channel 200 and a pair of liquid inlet holes 301 and 302 (303 and 304) are respectively arranged at two ends of the main channel 200, the same or different micro samples can be generated in the main channel 200 by respectively utilizing the liquid inlet holes 301 and 302 (303 and 304), and waste liquid is discharged via the same liquid storage hole 501.

Optionally, in the above generation chip provided in some embodiments of the present disclosure, as shown in FIG. 3 to FIG. 8, the main channel 200 can be a linear-shaped channel; as shown in FIG. 3, FIG. 4 and FIG. 8, the connecting channels 601 and 602 can be consistent with the extension direction of the main channel 200, so as to facilitate flowing of the liquid from the main channel 200 to the liquid storage holes 501 and 502. Moreover, at one end of the main channel 200, sample inlet channels 401 and 402 (403 and 404) connected by a pair of liquid inlet holes 301 and 302 (303 and 304) and a connecting channel 601 (602) connected through a liquid storage hole 501 (502) can constitute a cross-structured flow channel, that is, a cross-shaped convective structure.

Or, as shown in FIG. 7, the connecting channel can also be not consistent with the extension direction of the main channel 200, for example, the two can be in a vertical relationship, and this is not limited herein.

Optionally, in the above generation chip provided in some embodiments of the present disclosure, as shown in FIG. 3, at two ends of the main channel 200, the main channel 200 is respectively communicated with two liquid storage holes 501 and 502 through connecting channels 601 and 602, and the lengths of the connecting channels 601 and 602 are the same. Or, the lengths of the connecting channels 601 and 602 can also be different, and this will not be limited herein. During practical applications, the lengths of corresponding connecting channels 601 and 602 can be selected according to the property of micro samples which need to be generated.

It should be noted that, in the above generation chip provided in some embodiments of the present disclosure, the widths of the main channel 200, the sample inlet channels 401 and 402 (403 and 404) and the connecting channels 601 and 602 are not limited, the widths of the three can be the same, and can also be different. Moreover, the lengths of the main channel 200, the sample inlet channels 401 and 402 (403 and 404) and the connecting channels 601 and 602 are not limited, and can be set according to actual requirements. In addition, the shapes of the liquid inlet holes 301 and 302 (303 and 304) and the liquid storage holes 501 and 502 are also not limited, and the liquid inlet holes 301 and 302 (303 and 304) and the liquid storage holes 501 and 502 can be circular or of other shapes.

Optionally, in the above generation chip provided in some embodiments of the present disclosure, the material of the substrate 100 is generally glass, such that the preparation of generation chip can be compatible into the existing production lines of display panels, so as to lower cost. Or, the substrate 100 can also be made of other materials, and the materials are not limited herein.

Optionally, the above generation chip provided in some embodiments of the present disclosure can be prepared through a photolithographic etching process, thereby being beneficial for being compatible with the existing production lines of display devices, to lower production cost. Optionally, the preparation method of generation chip can include the following steps:

(1) Photoetching: placing a mask on the glass substrate with a chromium layer coated with photoresist, exposing on the photoetching machine for 7 s, after exposure, immersing the glass substrate in 0.7% NaOH solution to develop for 15 s to 20 s, afterwards, rinsing clean immediately in flowing ultrapure water, and placing in a drying oven of 120° C. and hardening for 30 minutes;

(2) Dechroming: after hardening, placing the glass substrate in a dechroming solution and gently shaking for 2 minutes, and washing with ultrapure water after the chromium layer which is to be exposed falls off;

(3) Wet etching for the first time: using transparent tape to protect one surface of the glass substrate without a chromium layer, immersing the glass substrate into a plastic vessel with an etching solution, performing wet etching for 30 minutes at room temperature, and flushing clean the glass substrate with ultrapure water;

(4) Removing optical contact: treating corroded glass substrate with a degumming solution, and taking out the glass substrate to wash after the surface of the glass substrate turns bright yellow from reddish brown;

(5) Dechroming again: removing the remaining chromium layer with dechroming solution;

(6) Wet etching for the second time: protecting the reaction cavities at the reverse side and front side of the glass substrate and the main channel, exposing the remaining part, performing wet etching for 30 minutes, and after etching, flushing clean the glass substrate with ultrapure water; and

(7) Wet etching for the third time: removing the protective layer of the main channel part, exposing the remaining part, and performing wet etching again for 100 minutes and cleaning up.

It should be noted that, such parameters as time and temperature occurred in the above preparation process are merely enumerated for illustration, and are not used as limiting conditions.

As to the above method for generating micro samples and generation chip provided in some embodiments of the present disclosure, samples are injected into a pair of liquid inlet holes simultaneously by utilizing two polyelectrolytes which have opposite charges and substantively the same molecular proportions, such that the polyelectrolyte solutions are converged in the main channel, and micro-droplets which have normalized shapes and orderly arrangement and which are closer to the actual organism environment can be formed in situ in different sites by utilizing the liquid phase separation of the compound. Compared with the generation mode of traditional droplet generators, that is, a mode in which the micro-droplets generated at the same position need to be brought away by liquid flows to continuously generate micro-droplets, the problem of solution waste caused by viscous adhesion of generated micro-droplets, which require a large quantity of liquid flow to flush so as to continuously generate droplets, in the prior generating mode can be avoided. Moreover, since in the generation process of micro-droplets, the micro-droplets generated at the liquid converged interface of two polyelectrolyte solutions in the main channel are in two different adjacent environments, therefore, the micro-droplets themselves correspondingly have the property of anisotropy.

Evidently, those skilled in the art can make various modifications and variations to the present disclosure without departing from the spirit and scope of the present disclosure. Accordingly, the present disclosure is also intended to encompass these modifications and variations thereto so long as the modifications and variations come into the scope of the claims appended to the disclosure and their equivalents.

1. A method for generating micro samples, comprising:
simultaneously adding polyelectrolyte solutions with opposite charges respectively at a set flow rate to at least one pair of liquid inlet holes of a pretreated generation chip of micro samples;
wherein proportions of positive charges and negative charges of the polyelectrolyte solutions added to the pair of liquid inlet holes are substantively same;
respectively controlling sample inlet channels through which the polyelectrolyte solutions in the liquid inlet holes enter the generation chip to be communicated with the liquid inlet holes; and
controlling convergence of the polyelectrolyte solutions entering the sample inlet channels in a main channel of the generation chip, and forming in situ micro samples of a compound with a set diameter in the main channel within a set recombination time.

2. The method of claim 1, wherein longer the set recombination time is, higher the concentration of the polyelectrolyte solutions is, and bigger the diameter of the micro samples of a compound is.

3. The method of claim 1, wherein in response to that the set recombination time is unchanged, higher the concentration of the polyelectrolyte solutions is, bigger the diameter of the micro samples of a compound is.

4. The method of claim 1, wherein the polyelectrolyte solution is a mixture of DNA solution and FITC-labeled polylysine solution;
a concentration ratio of the DNA solution to the FITC-labeled polylysine solution is 1.5:1.

5. The method of claim 4, wherein the concentration of the FITC-labeled polylysine solution is in a range of 1 mg/mL to 4 mg/mL; and the concentration of the DNA solution is in a range of 1.5 mg/mL to 6 mg/mL.

6. The method of claim 5, wherein the concentration of the FITC-labeled polylysine solution is 1 mg/mL, and the concentration of the DNA solution is 1.5 mg/mL;
the forming in situ micro samples of a compound with a set diameter in the main channel within a set recombination time comprises:
forming in situ micro samples of a compound with a diameter of 20 μm in the main channel when the set recombination time is 4 minutes.

7. The method of claim 5, wherein the concentration of the FITC-labeled polylysine solution is 4 mg/mL, and the concentration of the DNA solution is 6 mg/mL;
the forming in situ micro samples of a compound with a set diameter in the main channel within a set recombination time comprises:
forming in situ micro samples of a compound with a diameter of 20 μm in the main channel when the set recombination time is in a range of 1.5 minutes to 2 minutes.

8. The method of claim 1, wherein the respectively adding polyelectrolyte solutions with opposite charges at a set flow rate comprises:
adding polyelectrolyte solutions with opposite charges respectively at set flow rates which are substantively same.

9. The method of claim 1, wherein the set flow rate is less than or equal to 1 μL/min.

10. The method of claim 1, wherein after forming micro samples of a compound with a set diameter, the method further comprises: removing waste liquid from the liquid inlet holes and the liquid storage holes which are communicated with the main channel of the generation chip.

11. The method of claim 10, wherein after the waste liquid is removed, the generation method further comprises: adding buffer solution to the liquid inlet holes and the liquid storage holes.

12. The method of claim 1, wherein the pretreatment of the generation chips comprises:
treating the generation chip of the micro samples by adopting concentrated sulfuric acid, and flushing the generation chip of the micro samples treated with concentrated sulfuric acid by adopting secondary deionized water;
treating the generation chip of the micro samples flushed with the secondary deionized water by adopting a sodium hydroxide solution, and flushing the generation chip of the micro samples treated with the sodium hydroxide solution by adopting the secondary deionized water; and
treating the generation chip of the micro samples flushed with the secondary deionized water by adopting a hydrochloric acid solution, and flushing the generation chips of the micro samples treated with the hydrochloric acid solution by adopting secondary deionized water, such that the sample inlet channels and the main channel of the generation chip of the micro samples are substantively neutral.

13. The method of claim 8, wherein after pretreating the generation chip of the micro samples, and before adding polyelectrolyte solutions with opposite charges at a set flow rate to at least one pair of liquid inlet holes of pretreated generation chip of micro samples, the method further comprises: flushing the generation chip of the micro samples by adopting a buffer solution.

14. The method of claim 13, wherein the buffer solution is a 0.2×PBS solution containing polyvinylpyrrolidone;
a mass percentage of polyvinylpyrrolidone is 1%.

15. A generation chip of micro samples, comprising: a substrate, a main channel arranged on the substrate, at least one pair of liquid inlet holes, and sample inlet channels which are in one-to-one correspondence with the liquid inlet holes, wherein
one end of the sample inlet channel is communicated with a corresponding liquid inlet hole, and other end is communicated with the main channel;
mirror images of two liquid inlet holes in the pair of liquid inlet holes are arranged at two sides of an extension direction of the main channel, the pair of liquid inlet holes are configured to be respectively added with polyelectrolyte solutions with opposite charges at a set flow rate, such that the polyelectrolyte solutions in the liquid inlet holes are converged at the main channel of the generation chip respectively through the sample inlet channels of the generation chip, and micro samples of a compound with a set diameter are generated in situ in the main channel in a preset recombination time; wherein proportions of positive charges and negative charges of the polyelectrolyte solutions added to the pair of liquid inlet holes are substantively same.

16. The generation chip of claim 15, wherein in at least one end of the main channel, the main channel is communicated with the pair of liquid inlet holes through the sample inlet channels.

17. The generation chip of claim 15, wherein the main channel is a linear-shaped channel, the sample inlet channels is vertical to an extension direction of the main channel.

18. The generation chip of claim 15, wherein the main channel is a linear-shaped channel, a certain angle is formed between the sample inlet channels and an extension direction of the main channel.

19. The generation chip of claim 15, further comprises liquid storage holes arranged on the substrate, and connecting channels which are in one-to-one correspondence with the liquid storage holes;
one end of the connecting channels is communicated with corresponding liquid storage holes, while other end is communicated with the main channel.

20. The generation chip of claim 19, wherein the main channel is a linear-shaped channel;
wherein an extension direction of the connecting channels is consistent with an extension direction of the main channel, or an extension direction of the connecting channels is not consistent with an extension direction of the main channel.
